(19) United States
(12) Patent Application Publication
(10) Pub. No.: US 2026/0228192 A1
(43) Pub. Date: Aug. 6, 2026

(54) REUSABLE RETRIEVAL-AUGMENTED GENERATION PIPELINES

(71) Applicant: SAP SE, Walldorf (DE)

(72) Inventors: Vedant GUPTA, Bangalore (IN); Praveen Kumar PADEGAL, Bangalore (IN); PVN PavanKumar, Bangalore (IN)

(21) Appl. No.: 19/001,813

(22) Filed: Dec. 26, 2024

(51) Int. Cl. G06F 16/215; G06F 16/21

(52) U.S. Cl. CPC G06F 16/215; G06F 16/217

(57) ABSTRACT

An enterprise Retrieval-Augmented Generation (“RAG”) pipeline data store may contain electronic records that represent RAG pipelines, each record including a pipeline identifier and at least one tuning parameter. A Generative Artificial Intelligence (“GenAI”) launchpad platform, associated with at least one Large Language Model (“LLM”), includes an enterprise RAG pipeline engine that accesses information associated with a first RAG pipeline that was created by a first tenant. The enterprise RAG pipeline engine receives from a user an adjustment to a tuning parameter of the first RAG pipeline (e.g., for document ingestion, chunk tuning, embed tuning, similarity search, and/or context tuning) and automatically calculates an overall pipeline credibility score for the adjusted first RAG pipeline. The pipeline engine may then display the overall pipeline credibility score to the user and store information about the adjusted first RAG pipeline into the RAG pipeline data store.

### BACKGROUND

A Large Language Model (“LLM”) may be used to achieve general-purpose language generation and other natural language processing processes. Based on language models, LLMs acquire these abilities by learning statistical relationships from substantial amounts of text (e.g., from a knowledge base) during a training process. LLMs can be used for Generative Artificial Intelligence (“GenAI”) by taking an input text or prompt and predicting future tokens or words using artificial neural networks. In some cases, an LLM may answer user queries in various contexts by cross-referencing knowledge sources. Some drawbacks of the basic LLM approach include presenting false information (or “hallucinations”) and responses with out-of-date or generic information.

To address these and other issues, Retrieval-Augmented Generation (“RAG”) optimizes the output of a LLM so that it references an authoritative knowledge base outside of the original training data sources. RAG can extend LLM capabilities to specific domains or an organization’s internal knowledge base without retraining the model. For example, FIG. 1 is a high-level system 100 RAG architecture that includes a LLM 110, a vector search 120, and a vector data store 130. FIG. 2 is a basic RAG method that begins with receiving a user query at S210. In response to the user query, the LLM 110 interprets the query using embedding at S220. A vector search 120 is performed using information in the vector data store 130 at S230. The vector data store 130 might be populated with, for example, with information gathered from a knowledge base of enterprise documents (e.g., emails, memos, reports, etc.). The vector search 120 returns relevant context information specific to that enterprise which is used by the LLM 110 to generate an appropriate response to the user query at S240. In this way, RAG redirects the LLM 110 to retrieve relevant context information from authoritative, pre-determined knowledge sources giving an organization control over the text output that is generated. In this way, RAG may provide a cost-effective AI implementation (because the LLM 110 doesn’t need to be retrained with the new data), and more current information can be included without retraining.

RAG has been very successful at presenting accurate information. However, it can be difficult, time consuming, and costly to efficiently generate correct answers – especially when there is a substantial amount of enterprise information and/or a large number of data sources to be searched. As a result, various parameters of a RAG system may be adjusted to tuned looking to improve answers. For example, the adjustments might seek to improve the cleanliness of data from the data sources provided as context to the LLM for answers. Similarly, the embedding model and the chunking algorithm might be adjusted, the retrieval system (including the vector database) might be fine-tuned, the LLM model and prompt generator might be changed, etc. The set of tuning adjustments may represent an RAG “pipeline” that is customized for a particular domain (e.g., Human Resource (“HR”) questions). When such changes are made, it is important to decide if those changes actually improve RAG performance.

It would therefore be desirable to provide enterprise RAG pipelines in a secure, automatic, and efficient manner.

### SUMMARY

According to some embodiments, methods and systems may include an enterprise RAG pipeline data store that contains electronic files representing RAG pipelines (each record including a pipeline identifier and at least one tuning parameter). A GenAI launchpad platform, associated with at least one LLM, includes an enterprise RAG pipeline engine that accesses information associated with a first RAG pipeline that was created by a first tenant. The enterprise RAG pipeline engine receives from a user an adjustment to a tuning parameter of the first RAG pipeline (e.g., for document ingestion, chunk tuning, embed tuning, similarity search, and/or context tuning) and automatically calculates an overall pipeline credibility score for the adjusted first RAG pipeline. The pipeline engine may then display the overall pipeline credibility score to the user and store information about the adjusted first RAG pipeline into the RAG pipeline data store.

Some embodiments comprise: means for accessing, by a computer processor of an enterprise RAG pipeline engine within a GenAI launchpad platform associated with at least one LLM, information in a RAG pipeline data store associated with a first RAG pipeline that was created by a first tenant, the RAG pipeline data store contains electronic records that represent RAG pipelines, each record including a pipeline identifier and at least one tuning parameter; means for receiving from a user an adjustment to a tuning parameter of the first RAG pipeline; means for automatically calculating an overall pipeline credibility score for the adjusted first RAG pipeline; means for displaying the overall pipeline credibility score to the user; and means for storing information about the adjusted first RAG pipeline into the RAG pipeline data store.

Some technical advantages of some embodiments disclosed herein are improved systems and methods to provide enterprise RAG pipelines in a secure, automatic, and efficient manner.

### BRIEF DESCRIPTION OF THE DRAWINGS

FIG. 1 is a high-level system RAG architecture.

FIG. 2 is a basic RAG method.

FIG. 3 is a more detailed system RAG architecture.

FIG. 4 is a high-level system architecture in accordance with some embodiments.

FIG. 5 is an enterprise RAG method according to some embodiments.

FIG. 6 is an AI launchpad system in accordance with some embodiments.

FIG. 7 is an example of RAG pipelines according to some embodiments.

FIG. 8 is a RAG pipeline platform in accordance with some embodiments.

FIG. 9 is another RAG pipeline method according to some embodiments.

FIG. 10 is a content filtering method according to some embodiments.

FIG. 11 is a RAG triad system in accordance with some embodiments.

FIG. 12 is a RAG repository system according to some embodiments.

FIG. 13 is an apparatus or platform according to some embodiments.

FIG. 14 is a portion of a RAG pipeline database in accordance with some embodiments.

FIG. 15 illustrates a tablet computer RAG pipeline user display according to some embodiments.

FIG. 16 is an operator or administrator RAG pipeline display in accordance with some embodiments.

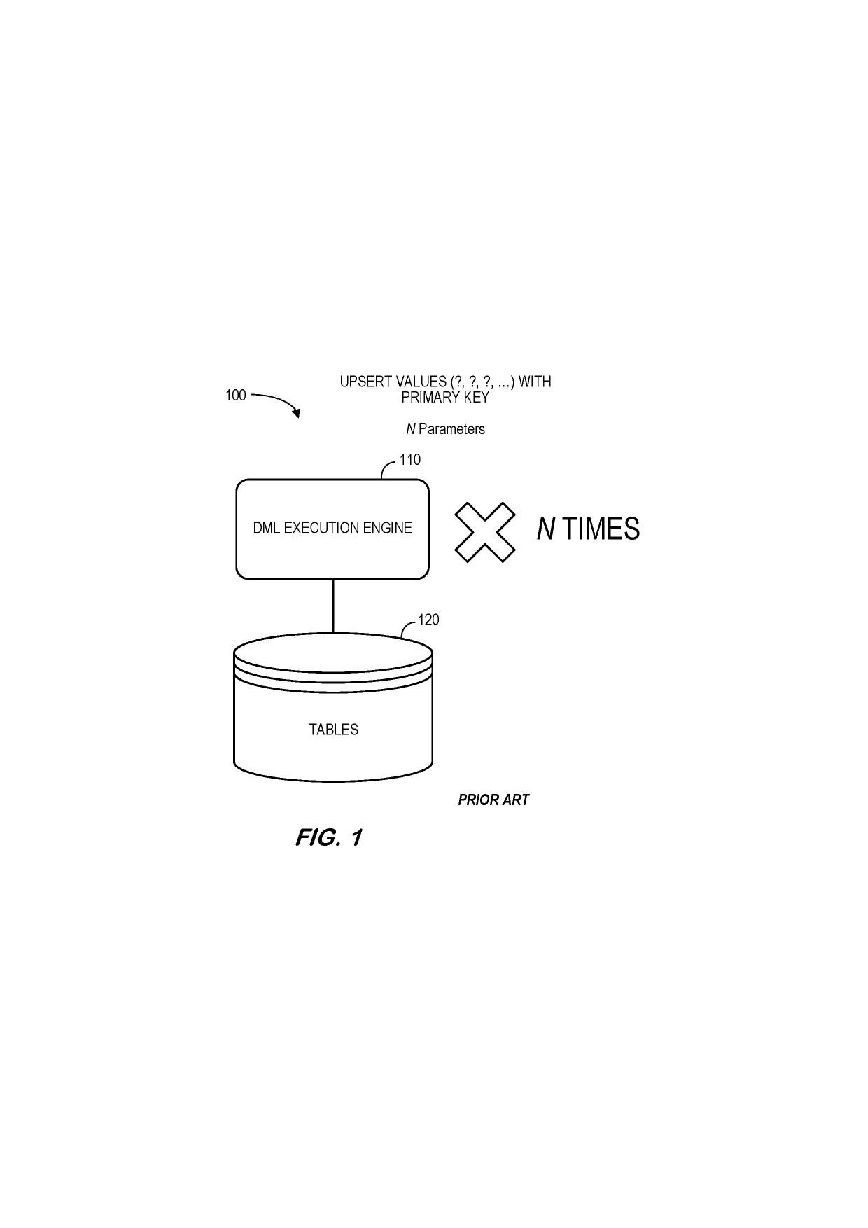

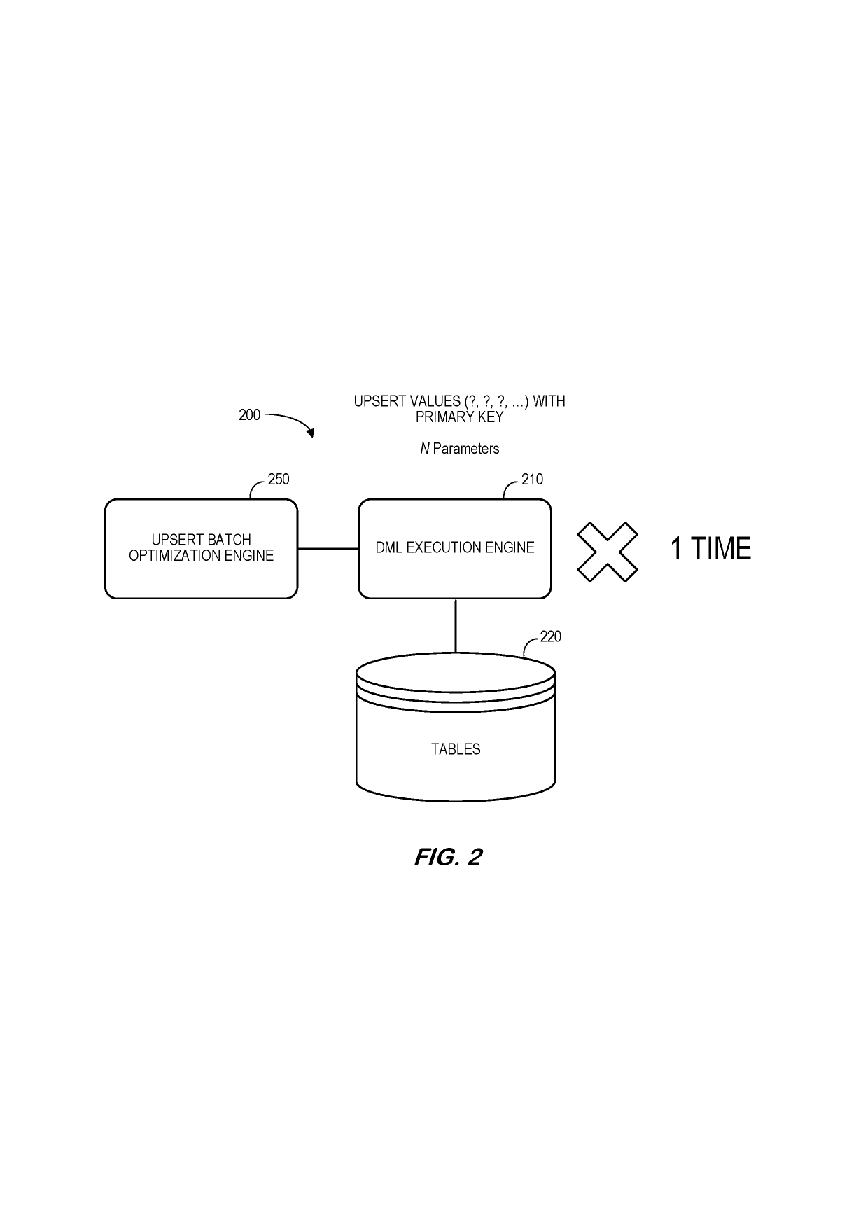

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

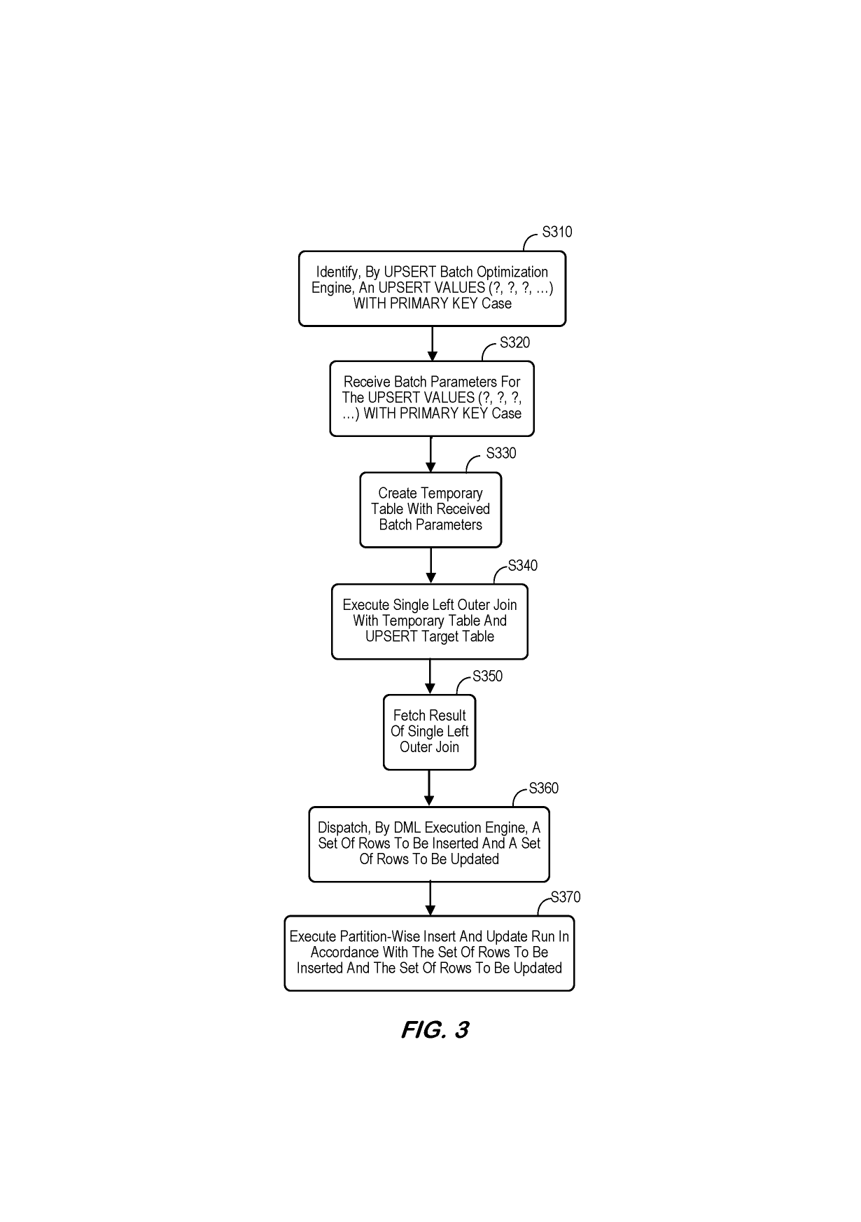

Given a user question, RAG attempts to find the most relevant snippets from a knowledge base to answer that question. FIG. 3 is a more detailed system 300 RAG architecture. In pre-processing, documents 320 from a knowledge base 310 are provided to an embedding model 330. This process may involve “chunking” the information. Note that the system 300 may be associated with a substantial volume of unstructured data (e.g., a corpus with many documents, a library of millions of pictures, thousands of hours of video, etc.). Chunking divides data up into chunks prior to storage, so that each one can be inspected for relevance to an input query during a search. The system 300 may include some overlap in these chunks, to avoid information being split between chunk boundaries (and thus lost). The size and format of these chunks can vary from application to application.

To provide answers in a useful timeframe, RAG needs to rapidly search a database of information on which it was not trained and return relevant pieces of context information. The system 300 may first map data to a numerical vector via “vector embedding.” As used herein, the phrase “vector embedding” may refer to the process of representing an arbitrary piece of unstructured data as an n-dimensional array of numbers. The numbers are not inherently meaningful or interpretable, but they provide a way of comparing two pieces of unstructured data by mapping them to a point in n-dimensional space. Similar pieces of data will sit close to one another in the vector space, and dissimilar pieces of data will be further away.

The embedding model 330 can then store information about embedded documents in a vector database 340. The vector database 340 might include, for each document, text content, vector values, metadata (e.g., a document title, enterprise identifier, date, and a source of the information), etc. As used herein, the phrase “vector database” may refer to a data store that is designed and optimized to handle vector data (as opposed to a tabular data stored by traditional relational databases). They provide efficient storage, indexing, and querying mechanisms (optimized for high-dimensional and variable-length vectors) and allow for flexible data storage and retrieval.

The retriever architecture 350 acts as an internal search engine – given a user query, it returns relevant snippets that originated in the knowledge base 310. The snippets are then fed to a reader architecture 360 to help it generate a response. Initially, the retriever architecture 350 receives a user query or question. The retriever architecture 350 includes an embedding model 352 that processes the user query. The embedded user query can then be used to access information from the vector database 340. For example, the system 300 might locate the top-k closest documents to the embedded user query based on semantic similarity. That is, the system wants to find the k documents that have the closest meaning by picking the k closest vectors. There are many ways of measuring the distance between vectors, such as Euclidean distance, Cosine distance, a dot product projection, Manhattan distance, any other state-of-the-art similarity search technique, etc.

This information is provided as context 362 in the reader architecture 360 that processes and aggregates document contents for use in an LLM prompt 364. Such a process may involve prompt compression and/or reranking techniques. As used herein, the term “reranking” may refer to retrieving more documents than needed and then reranking the results before selecting the top k. The LLM prompt 364 is then created based on the original user query and the additional relevant context 362. Finally, an LLM 366 converts the LLM prompt 364 into an RAG query answer or response.

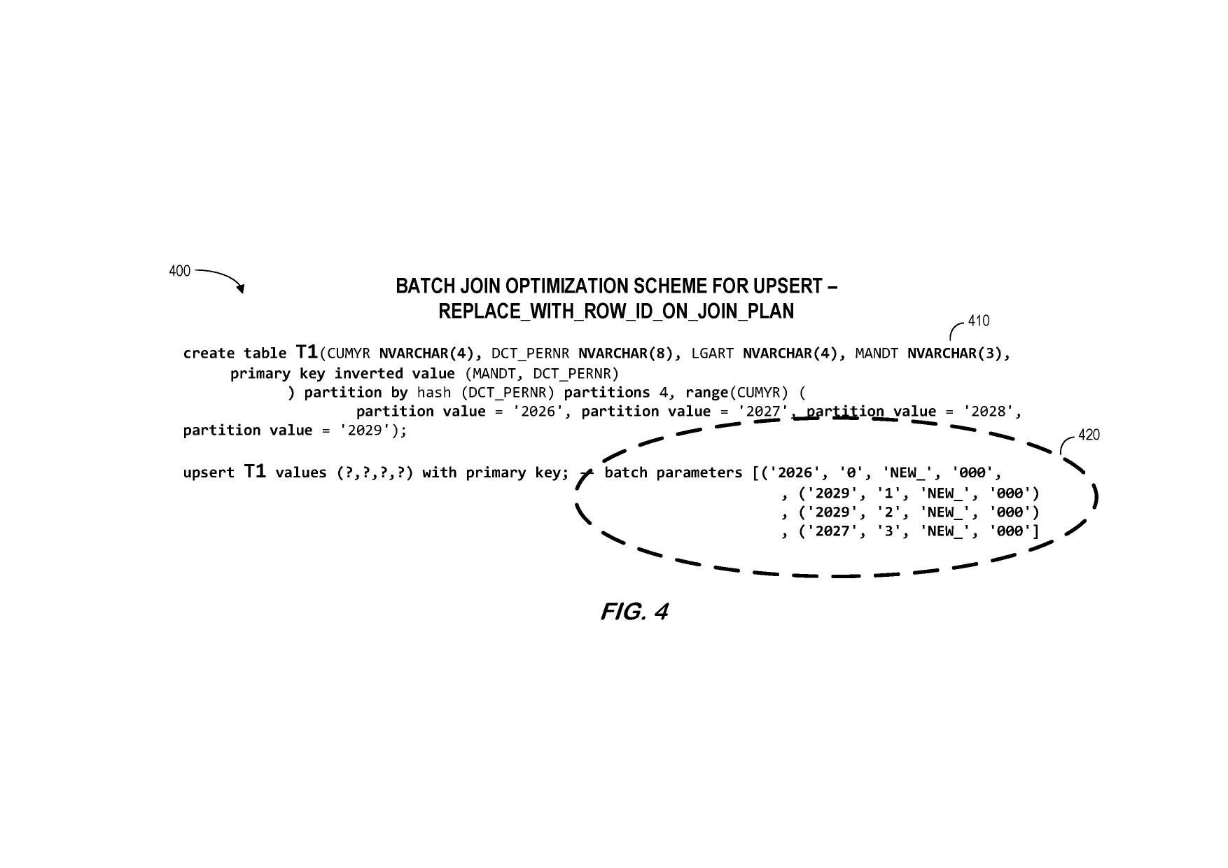

While the system 300 may help optimize an output of a LLM by referencing an authoritative knowledge base outside of the training data sources before generating a response, it would be helpful it could also efficiently and accurately provide RAG pipelines for the system 300 in a secure manner. FIG. 4 is a high-level block diagram of one example of a system 400 architecture according to some embodiments. In particular, a RAG pipeline data store 410 may contain electronic data records associated with RAG pipelines 412. Each RAG pipeline might, for example, be associated with a pipeline identifier 414, tuning parameters 416, etc. A GenAI launchpad platform 450 may comprise a multitenant Software as a Service (“SaaS”) application for a business technology platform. Customers and partners can use the GenAI launchpad platform 450 to manage AI use cases (e.g., “scenarios”) across multiple instances of AI runtimes. The GenAI launchpad platform 450 may also provide GenAI capabilities via a GenAI hub and interactions with first and second tenant devices 460, 470. According to some embodiments, the GenAI launchpad platform 450 includes an enterprise RAG pipeline engine 455 that creates and/or modifies RAG pipelines.

As used herein, devices, including those associated with the system 400 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The enterprise RAG pipeline engine 455 may store information into and/or retrieve information from various data stores (e.g., the RAG pipeline data store 410), which may be locally stored or reside remote from the enterprise RAG pipeline engine 455. Although a single launchpad platform 450 and enterprise RAG pipeline engine 455 are shown in FIG. 4, any number of such devices may be included. Moreover, various devices described herein might be combined according to embodiments of the present invention. For example, in some embodiments, the RAG pipeline data store 410 and the enterprise RAG pipeline engine 455 might comprise a single apparatus. The system 400 functions may be performed by a constellation of networked apparatuses, such as in a distributed processing or cloud-based architecture. In some cases, the enterprise RAG pipeline engine 455 may process information associated with a number of different enterprises.

The system 400 may be accessed via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how the elements connect with an enterprise computing environment infrastructure) and/or provide or receive automatically generated recommendations, alerts, summaries, or results associated with the system 400.

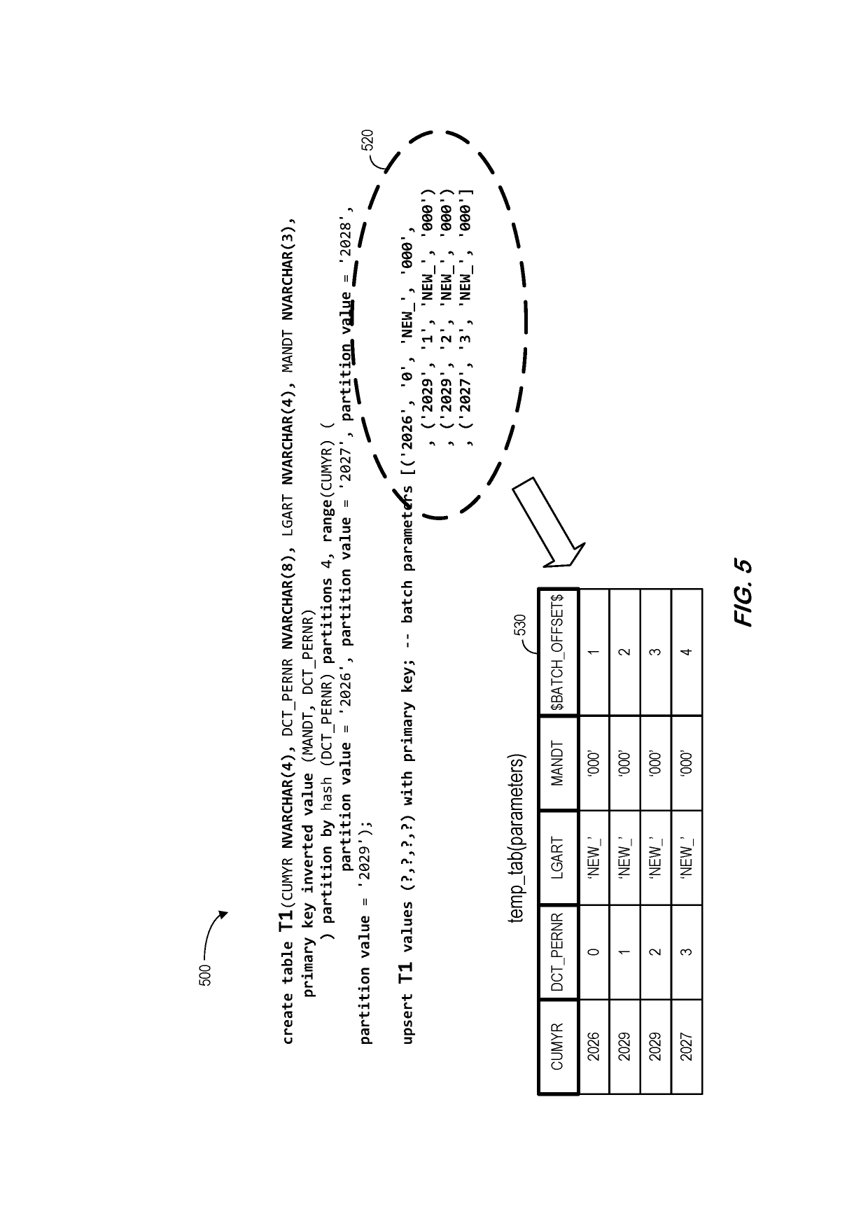

FIG. 5 is an enterprise RAG method that might be performed by some or all of the elements of the system 400 described with respect to FIG. 4. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S510, a computer processor of an enterprise RAG pipeline engine within a GenAI launchpad platform (associated with at least one LLM) may access information in a RAG pipeline data store for a first RAG pipeline that was created by a first tenant. At S520, the system may receive from a user an adjustment to a tuning parameter of the first RAG pipeline. The enterprise RAG pipeline engine can then automatically calculate an overall pipeline credibility score for the adjusted first RAG pipeline at S530 and display the overall pipeline credibility score to the user at S540. As used herein, the term “automatically” may refer to an action that requires little or no human intervention. At S550, information about the adjusted first RAG pipeline is stored into the RAG pipeline data store.

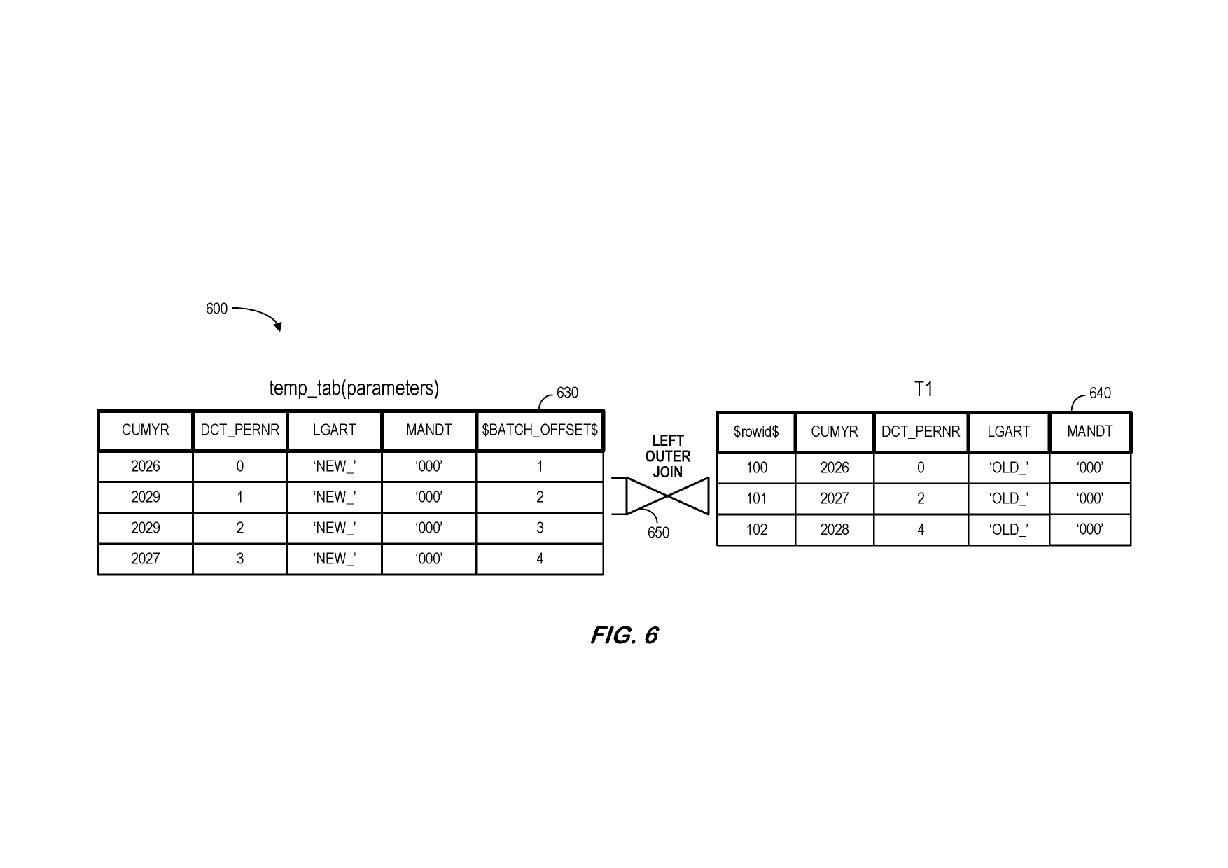

FIG. 6 is an AI launchpad system 600 in accordance with some embodiments. The system 600 includes an AI launchpad 620 (such the SAP® AI LAUNCHPAD™), with Machine Learning (“ML”) operations 622, a functions explorer 624, a GenAI hub 626 (such as the SAP® GEN AI HUB™), and an AI core administration component 628 to support ML operations engineers 612, business analysts 614, prompt engineers 616, and core administrators 618, respectively. The AI launchpad 620 communicates with an AI core 640, such as via workspaces 632 and an AI Application Programming Interface (“API”) connector 634.

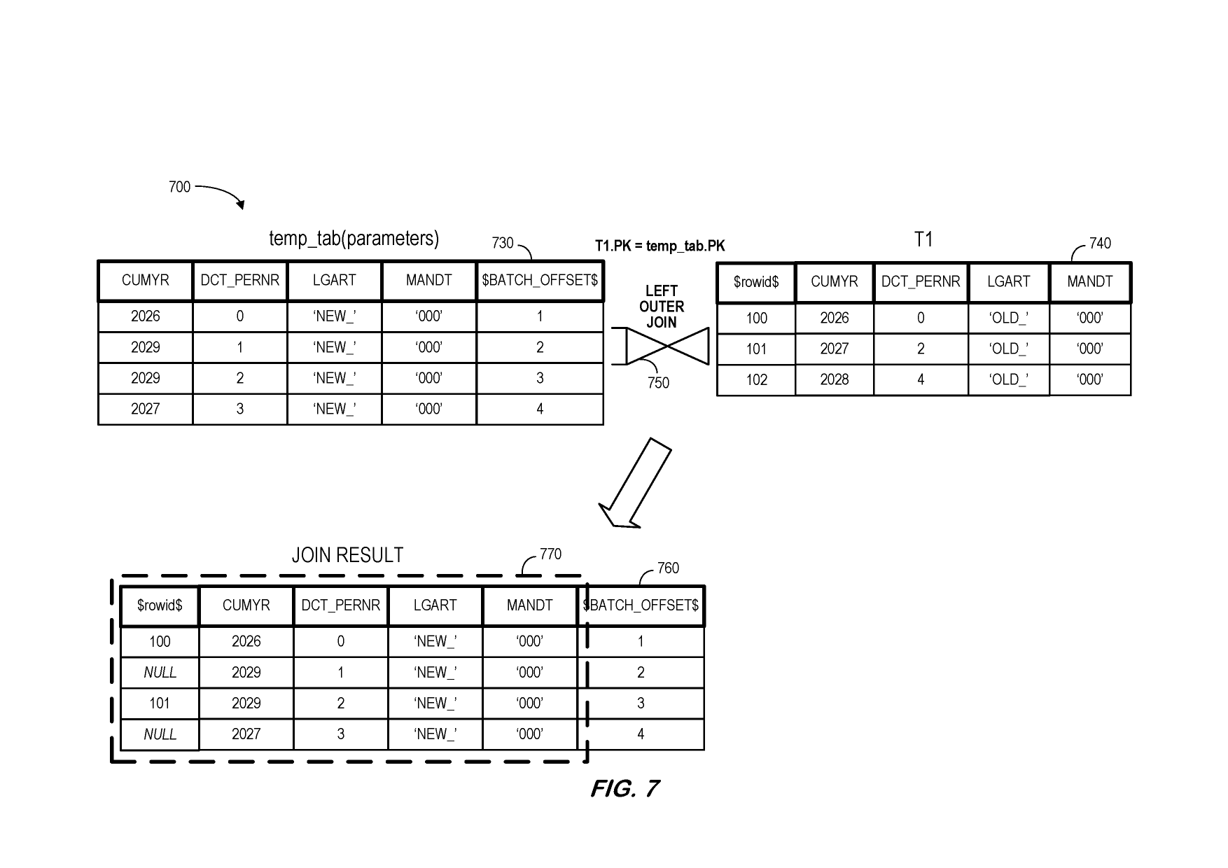

The AI core 640 includes an AI API 642, a main tenant 644, resource groups 646, and an AI model 648 (e.g., with executions for training and deployment to serve the AI model 648). According to some embodiments, the AI launchpad 620 further utilizes one or more re-usable RAG pipelines 650 (as described with respect to FIG. 7). Moreover, the AI core 640 may access templates and code 660 (e.g., associated with training and/or deployment), data storage 670 (e.g., hyperscaler object storage for data and models), etc.

In this way, embodiments may provide an approach to building and optimizing RAG pipelines. Designed for both technical and non-technical users, a no-code/low-code solution may centralize and simplify pipeline management. Traditionally, RAG pipelines demand significant manual configuration and fine-tuning (which can be time-consuming and complex). With the embodiments described herein, customers can experiment, optimize, and/or adjust pipelines and stages in a flexible way (accelerating deployment without needing in-depth coding knowledge).

FIG. 7 is an example 700 of tunable RAG pipelines 710, 720 (pipeline A and pipeline B) according to some embodiments. Each pipeline 710, 720 includes a document ingestion stage 711, 721 to handle various document types (e.g., text, table, database, etc.). Documents might be, for example, ingested from a custom corpus or database into the RAG system. The documents could be any form of textual or tabular data represented as .txt, .docx, .pdf, .csv., .xlsx, etc. and different extensions may need to be ingested differently.

A chunking stage 712, 722 may create chunks from an object (e.g., a sentence, a paragraph, etc.) based on chunk size, chunk overlap, etc. (which might be different for different document types and/or depend on document construction. The chunking breaks down the input documents into smaller, manageable chunks or segments. These chunks allow for more efficient processing and retrieval of relevant information during the generation process.

An embedding model stage 713, 723 may help determine performance of the pipeline as it governs retrieval quality. Vectors saved in a cloud vector engine after textual data is converted into numerical representations. These embeddings may capture the semantic meaning of the text and let mathematical operations be performed. Different embedding models might be used depending on the use case, computing capability, domain, etc.

A similarity stage 714, 724 may use mathematical algorithms to find the chunks that are closest to the user input query, such as L2, cosine, Jaccard, k-nearest neighbors, etc. Another tuning option might be the number of documents that will be retrieved to be passed to the LLM (upper bounded by context window size). Similarity search involves comparing the embeddings of the user query with the embeddings of the chunks in the document corpus. This comparison is performed to identify chunks that are semantically like the user query.

A context feeding stage 715, 725 may re-rank selected chunks to further reduce context. Tunable choices for this algorithm (e.g., neural network based, similarity based, etc.) might include the number of documents that will remain after re-ranking and the selection of an LLM (within a GenAI hub). Once relevant chunks are identified through similarity search, they can be fed into the context of the generation pipeline to provide additional information to the LLM (letting it generate more relevant and contextually appropriate responses).

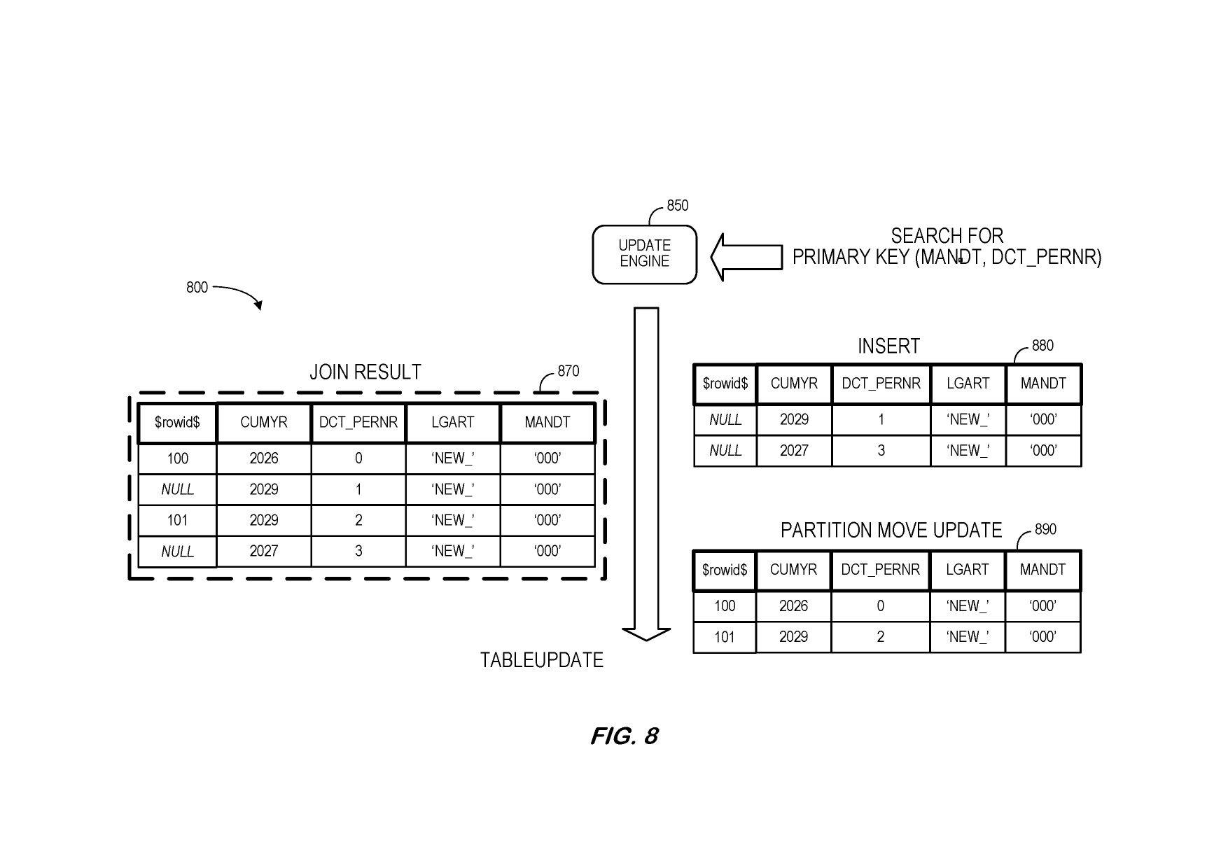

FIG. 8 is a RAG pipeline platform 800 in accordance with some embodiments. At (A), a custom knowledge base 810 may be ingested and provided to an embedding model 820 at (B). The embedding model 820 can then generate the vectors that are stored into a vector store 830 at (C). At (D), a user query 840 results in a similarity search using the vector to generate an appropriate context 850 at (E). The query 840 and context 850 are provided (e.g., via a foundation model 860) to an LLM 870 at (F), which in turn generates a contextualized response. In some embodiments, an evaluation stage might use multiple techniques based on aspects of RAG pipeline (e.g., use case, document structure in use, etc.). Moreover, the provision of actionable insights might allow for the tweaking of various RAG pipeline parameters before the RAG pipeline is exported as code 880 at (G) including the language and framework for the desired shipped code.

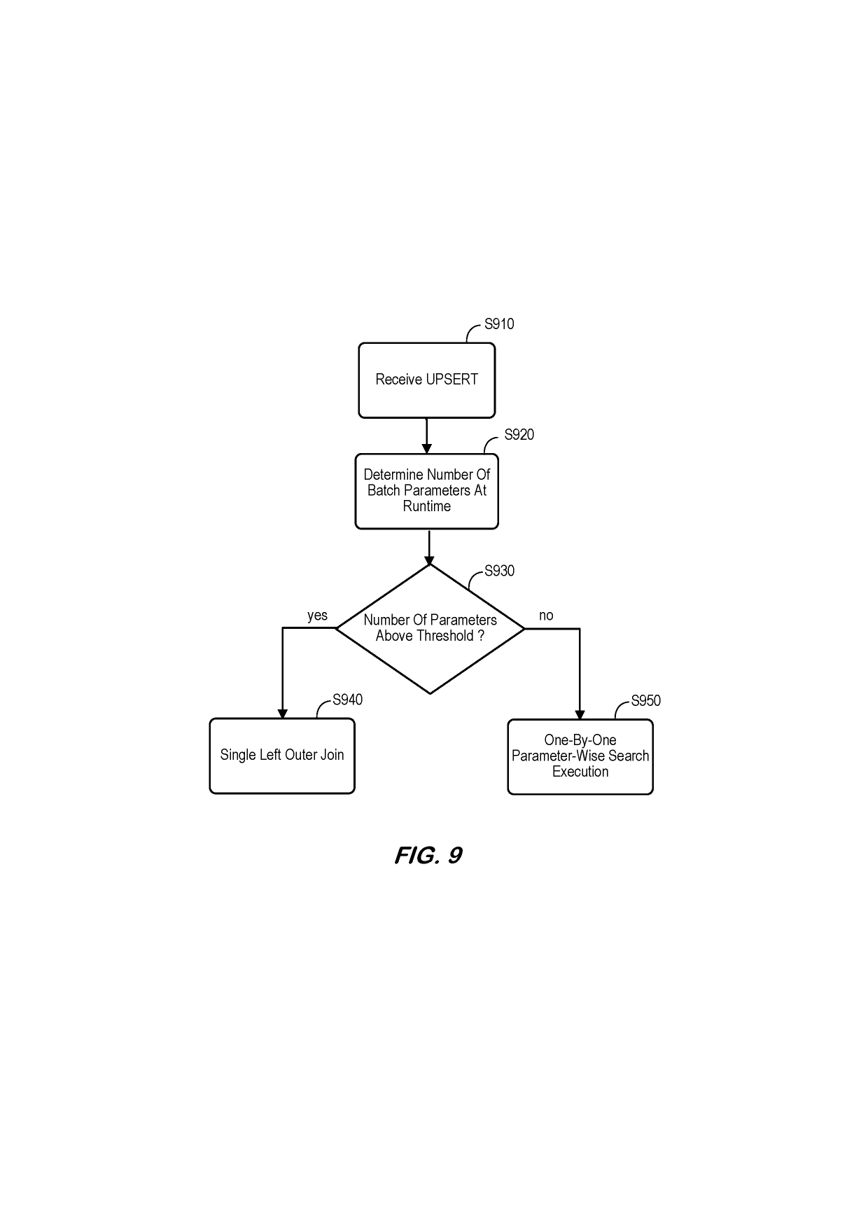

FIG. 9 is another RAG pipeline method according to some embodiments. At S910, an overall pipeline credibility score S910 may be calculated. This feature offers users a reliable, easy-to-understand metric to gauge output quality, helping to ensure that decision-makers can trust the results generated by the system. As customers increasingly rely on RAG pipelines for critical tasks (such as generating insights from internal documents or providing data-driven recommendations) this credibility score can be a tool to help maintain confidence.

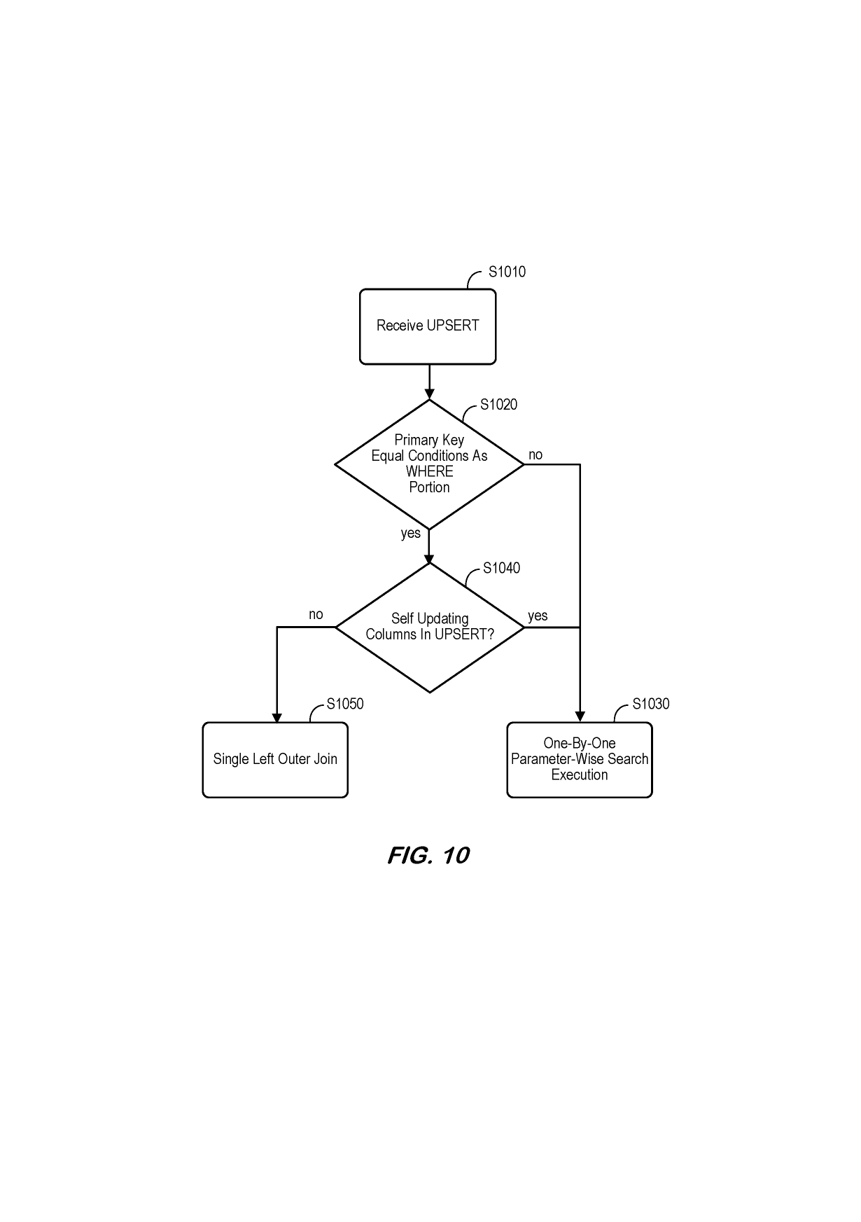

At S920, content filtering S920 (e.g., through an orchestration layer of a GenAI hub) may help ensure responsible use of LLMs by screening out sensitive, inappropriate, or harmful content. Customers operating in regulated industries (such as healthcare, legal, or finance) may especially benefit from this feature so that the generated outputs adhere to strict ethical guidelines and industry regulations. By building-in these compliance mechanisms, an enterprise may strengthen adherence to broader policy frameworks, letting customers deploy appropriate systems. For example, FIG. 10 is a content filtering method according to some embodiments. After RAG pipeline information is determined at S1010, any sensitive content found at S1020 is removed at S1030. Similarly, any inappropriate content found at S1040 is removed at S1030. Finally, any harmful content found at S1050 is removed at S1030. After all of the sensitive, inappropriate, and/or harmful content is removed, the remaining information is stored into a RAG pipeline data store at S1060.

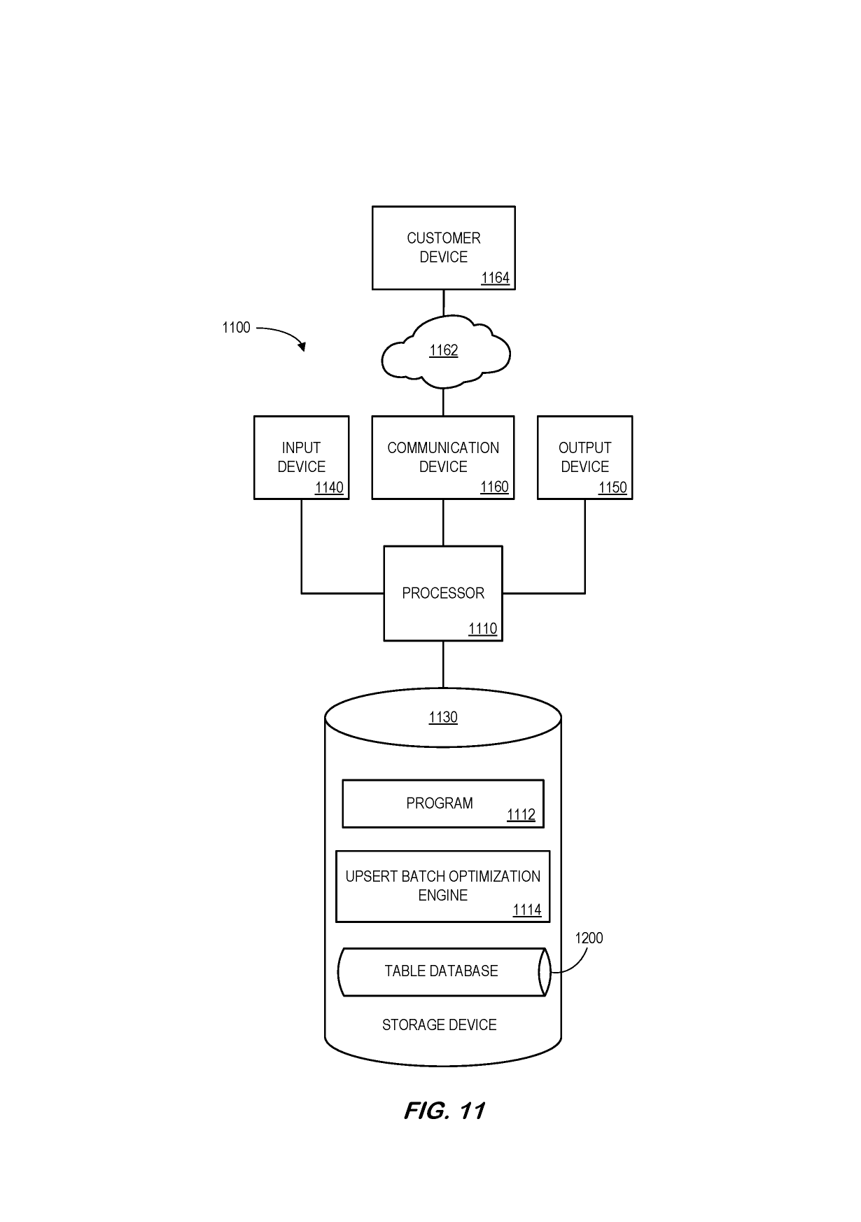

Referring again to FIG. 9, at S930 a RAG triad and feedback loop may be provided to help provide quality assessment. The RAG triad may comprise a sophisticated quality metric specifically designed to evaluate RAG pipelines. This triad may serve as a reliable tool for measuring the effectiveness of pipeline outputs, factoring in key elements such as retrieval accuracy, context relevance, and output coherence. By leveraging the RAG triad, users can confidently assess and improve RAG pipelines (knowing that they are guided by a robust and structured evaluation framework). In addition, embodiments may integrate a feedback loop that continuously monitors pipeline performance. The loop may analyze outputs at each stage and provide actionable insights (highlighting areas for improvement). Based on this feedback, users might receive steps suggested to fine-tune parameters (such as embedding models, chunking strategies, or similarity algorithms). FIG. 11 is a RAG triad system 1100 in accordance with some embodiments. A GenAI launchpad 1110 generates a RAG triad 1120 (including retrieval accuracy, context relevance, and output coherence). The RAG triad 1120 can then be included on a user display 1130 and or provided to the AI launchpad 1110 as feedback.

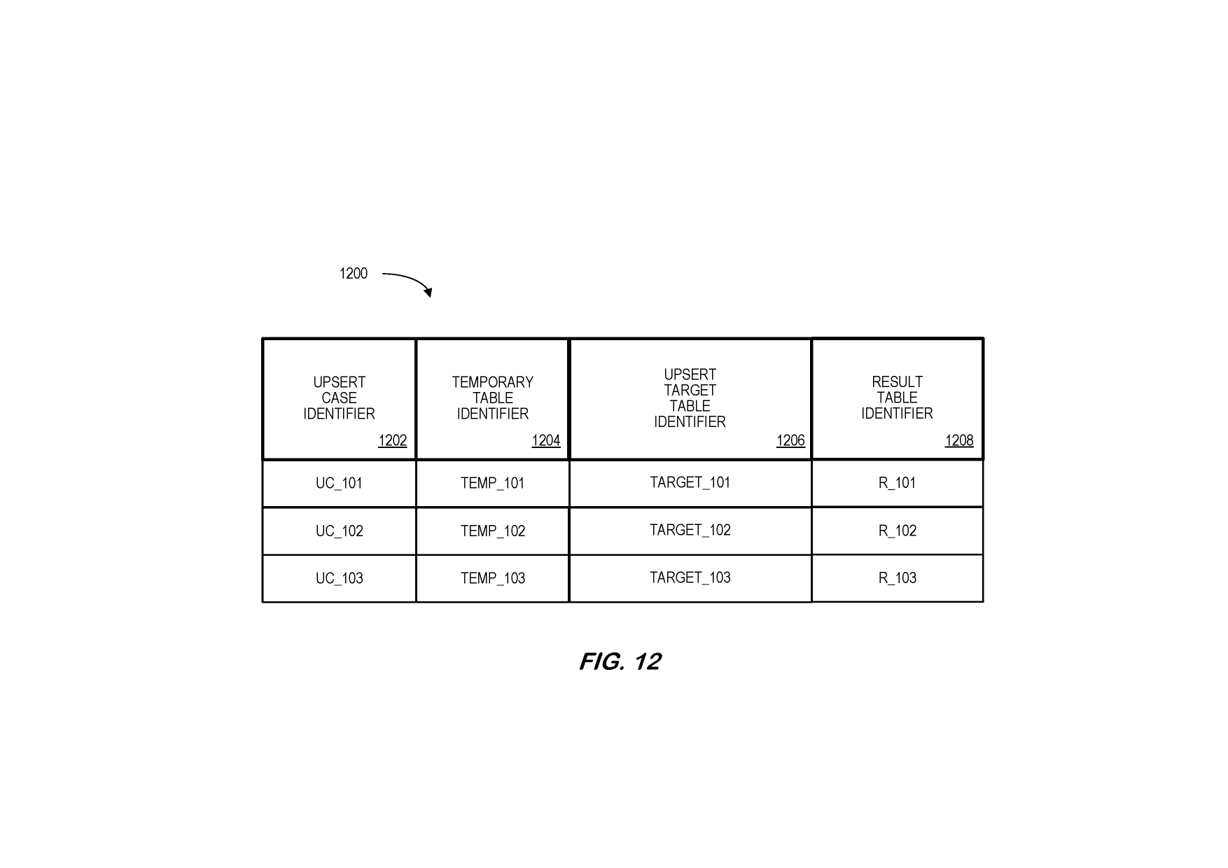

Referring again to FIG. 9, a RAG repository may let a user store and share pipelines tailored to specific document types at S940. For example, pipelines might be optimized for policy documents, Key Performance Indicator (“KPI”) documents, or other specialized formats that can be stored for future reuse. This feature may benefit customers by enabling them to access ready-made pipelines (significantly reducing development time and letting teams leverage pre-configured and validated pipelines across projects). FIG. 12 is a RAG repository system 1200 according to some embodiments. The system 1200 includes a repository 1250 (storing multiple pipelines) that can be accessed by multiple tenants 1210, 1220.

Referring again to FIG. 9, at S950 compliance may help ensure that customer data is not shared between users (only the pipeline structure and other configurations might be available). In this way, customers can safely reuse and benefit from other pipeline designs, knowing that any sensitive data remains completely private and secure. This collaborative approach empowers teams to innovate faster without compromising security, helping customers maintain high-quality standards while safeguarding proprietary information.

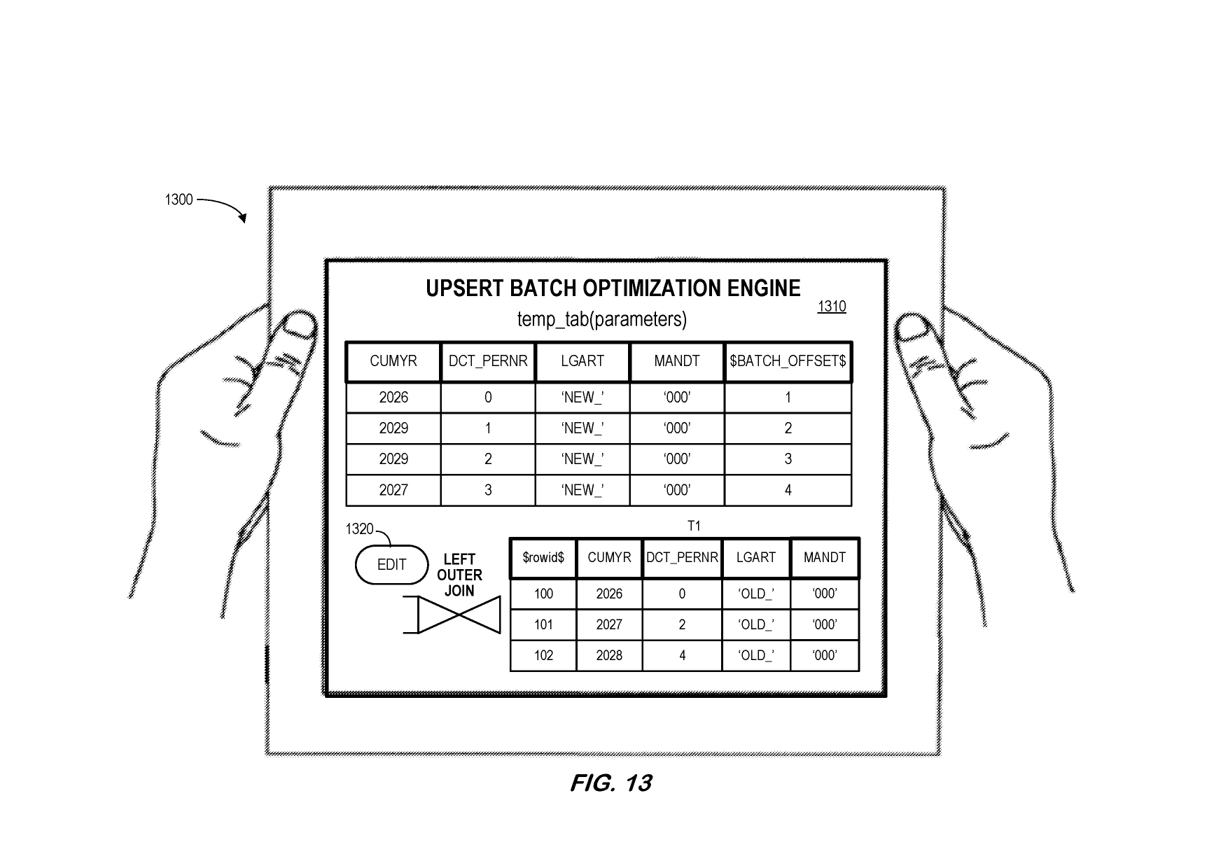

Embodiments described herein may be implemented using any number of different hardware configurations. For example, FIG. 13 is a block diagram of an apparatus or platform 1300 that may be, for example, associated with the system 400 of FIG. 4 (and/or any other system described herein). The platform 1300 comprises a processor 1310, such as one or more commercially available Central Processing Units (“CPUs”) in the form of one-chip microprocessors, coupled to a communication device 1360 configured to communicate via one or more communication networks. The communication device 1360 may be used to communicate, for example, with one or more tenant devices 1364 via a distributed computer network 1362. The platform 1300 further includes an input device 1340 (e.g., a computer mouse and/or keyboard to input data source information, chunking rules and logic, etc.) and/an output device 1350 (e.g., a computer monitor to render a display, transmit recommendations, evaluations, alerts, reports about RAG results, etc.).

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1312 and/or RAG pipeline engine 1314 for controlling the processor 1310. The processor 1310 performs instructions of the programs 1312, 1314, and thereby operates in accordance with any of the embodiments described herein. For example, the processor 1310 may receive from a user an adjustment to a tuning parameter of an RAG pipeline (e.g., for document ingestion, chunk tuning, embed tuning, similarity search, and/or context tuning) and automatically calculate an overall pipeline credibility score for the adjusted RAG pipeline. The processor 1310 may then display the overall pipeline credibility score to the user and store information about the adjusted RAG pipeline.

The programs 1312, 1314 may be stored in a compressed, uncompiled and/or encrypted format. The programs 1312, 1314 may furthermore include other program elements, such as an operating system, clipboard application, a database management system, and/or device drivers used by the processor 1310 to interface with peripheral devices.

As used herein, information may be “received” by or “transmitted” to, for example: (i) the platform 1300 from another device; or (ii) a software application or module within the platform 1300 from another software application, module, or any other source.

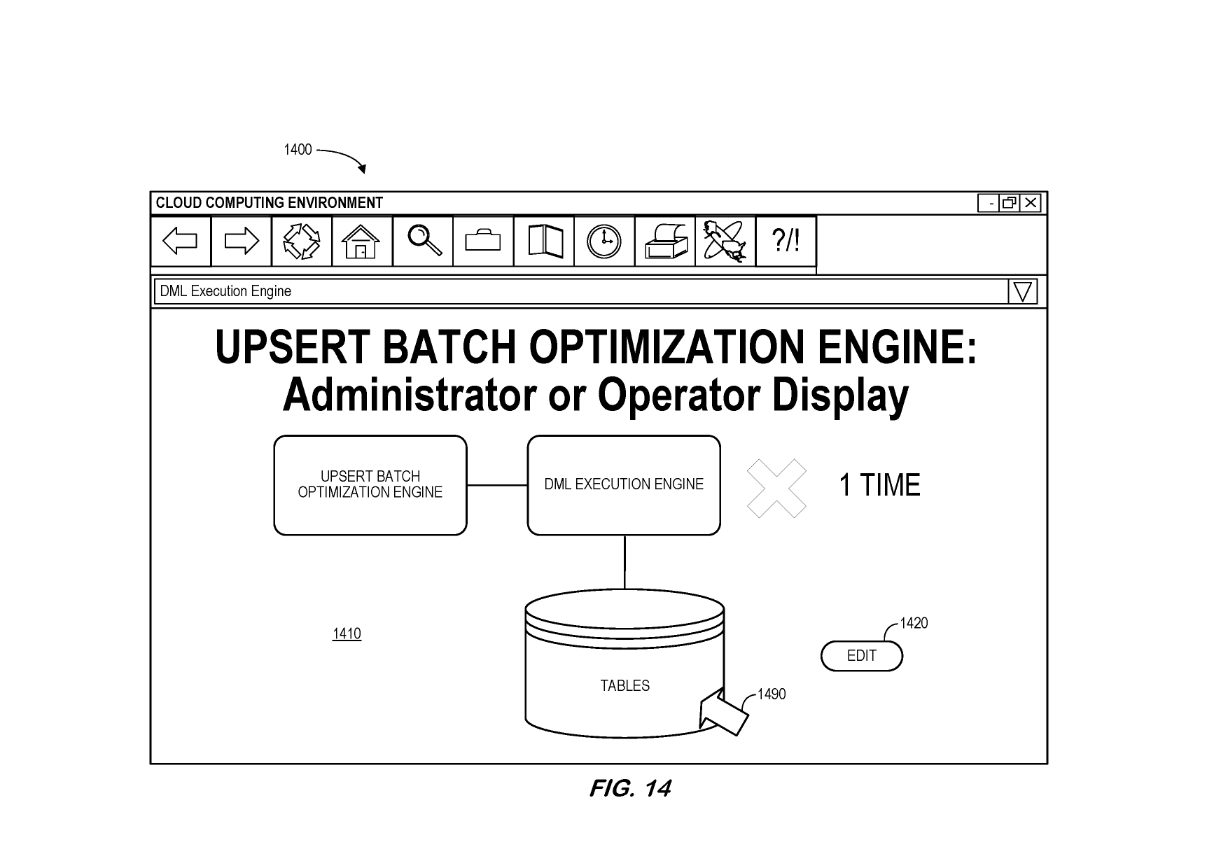

In some embodiments (such as the one shown in FIG. 13), the storage device 1330 further stores AI launchpad data 1370 and a RAG pipeline database 1400. An example of a database that may be used in connection with the platform 1300 will now be described in detail with respect to FIG. 14. Note that the database described herein is only one example, and additional and/or different information may be stored therein. Moreover, various databases might be split or combined in accordance with any of the embodiments described herein.

Referring to FIG. 14, a table is shown that represents the RAG pipeline database 1400 that may be stored at the platform 1300 according to some embodiments. The table may include, for example, entries representing available RAG pipelines that have been created. The table may also define fields 1402, 1404, 1406, 1408, 1410 for each of the entries. The fields 1402, 1404, 1406, 1408, 1410 may, according to some embodiments, specify: a RAG pipeline identifier 1402, a creator tenant and user 1404, tuning parameters 1406, an overall pipeline credibility score 1408, and a RAG triad 1410. The RAG pipeline database 1400 may be created and updated, for example, when new enterprise RAG pipelines are added, fine tune adjustments are made, etc.

The RAG pipeline identifier 1402 might be a unique alphanumeric label for a customized RAG pipeline that automatically embeds the most current and relevant data directly into an LLM prompt (including structured data like a spreadsheet or a relational database and unstructured data such as emails, PDFs, chat logs, social media posts, etc.). The creator tenant and user 1404 indicates who made the RAG pipeline and the tuning parameters 1406 define the RAG (e.g., including parameters for document ingestion, chunk tuning, embed tuning, similarity search, context tuning etc.). The overall pipeline credibility score 1408 reflects the performance of the RAG pipeline while the RAG triad 1410 provides further details (including retrieval accuracy, context relevance, and output coherence metrics).

In this way, embodiments may provide a platform for experimentation with adjustable parameters to streamline the process and achieve optimal outcomes. In some embodiments, the challenge of efficiently experimenting with RAG pipeline parameters is addressed by introducing a reusable asset within a GenAI hub. The tool may streamline parameter tuning and experimentation with a user-friendly dashboard accessible via an AI Launchpad. Embodiments may provide an ability to adjust parameters at different pipeline steps (e.g., document ingestion, chunking, embedding, similarity search, and re-ranking) using intuitive switches and knobs while providing insights about each setting’s impact on the final outcome. Additionally, embodiments may include an evaluation step, simplifying the complex task of assessing generated results. Furthermore, embodiments may offer functionality to export the tuned pipeline as code for seamless integration into different applications. By catering to both professional non- professional developers, embodiments may improve the development of efficient RAG pipelines, shorten timelines, and eliminate the need for extensive review of framework documentation.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of use cases, any of the embodiments described herein could be applied to other types of use cases.

In addition, the displays shown herein are provided only as examples, and any other type of user interface could be implemented. For example, FIG. 15 illustrates a tablet computer 1500 providing a RAG pipeline user display 1510 according to some embodiments. The display 1510 might be used, for example, to inform the user about tuning parameters and/or performance metrics. A user may interact with the display 1510, such as via an “Edit” icon 1520 (e.g., to change fine tune or adjust RAG turning parameter rules or logic, etc.).

FIG. 16 is an enterprise RAG evaluation framework display 1600 in accordance with some embodiments. The display 1600 includes a graphical representation 1610 of an AI framework in accordance with any of the embodiments described herein. Selection of an element on the display 1600 (e.g., via a touchscreen or computer pointer 1690) may result in display of a pop-up window containing more detailed information about that element and/or various options (e.g., to define how a data source interacts with the framework, how users communicate with the framework, etc.). Selection of an “Edit” icon 1620 may also let an operator or administrator adjust the operation of the system (e.g., to change a mapping to a data store, tune chunk size parameters, make changes to embedding models or internal LLMs, add new RAG pipelines, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A system, comprising:
a Retrieval-Augmented Generation (“RAG”) pipeline data store containing electronic records that represent RAG pipelines, each record including a pipeline identifier and at least one tuning parameter; and
a Generative Artificial Intelligence (“GenAI”) launchpad platform, coupled to the RAG pipeline data store and being associated with at least one Large Language Model (“LLM”), including:
an enterprise RAG pipeline engine, including:
a computer processor, and
a computer memory storing instructions that, when executed by the computer processor, cause the enterprise RAG pipeline engine to:
access information in the RAG pipeline data store associated with a first RAG pipeline that was created by a first tenant,
receive from a user an adjustment to a tuning parameter of the first RAG pipeline,
automatically calculate an overall pipeline credibility score for the adjusted first RAG pipeline,
display the overall pipeline credibility score to the user, and
store information about the adjusted first RAG pipeline into the RAG pipeline data store.

2. The system of claim 1, wherein each RAG pipeline is associated with at least one of: (i) a document ingestion tuning parameter, (ii) a chunk tuning parameter, (iii) an embed tuning parameter, (iv) a similarity search tuning parameter, and (v) a context tuning parameter.

3. The system of claim 1, wherein the enterprise RAG pipeline engine is further to perform content filtering to ensure that the RAG pipeline data store does not contain at least one of: (i) sensitive content, (ii) inappropriate content, and (iii) harmful content.

4. The system of claim 1, wherein the overall pipeline credibility score includes a RAG triad comprising all of: (i) a retrieval accuracy metric, (ii) a context relevance metric, and (iii) an output coherence metric.

5. The system of claim 4, wherein information about the RAG triad is provided to a feedback loop to continuously improve pipeline performance via suggested tuning parameters.

6. The system of claim 1, wherein different RAG pipelines are associated with different document types.

7. The system of claim 1, wherein the information about the adjusted first RAG pipeline that is stored into the RAG pipeline data store is accessible by a second tenant.

8. The system of claim 7, wherein the RAG pipeline data store includes information about pipeline structure without including sensitive tenant information.

9. The system of claim 1, wherein the information about the adjusted first RAG pipeline that is stored into the RAG pipeline data store is accessible to multiple applications.

10. A computer-implemented method, comprising:
accessing, by a computer processor of an enterprise Retrieval-Augmented Generation (“RAG”) pipeline engine within a Generative Artificial Intelligence (“GenAI”) launchpad platform associated with at least one Large Language Model (“LLM”), information in a RAG pipeline data store associated with a first RAG pipeline that was created by a first tenant, the RAG pipeline data store contains electronic records that represent RAG pipelines, each record including a pipeline identifier and at least one tuning parameter;
receiving from a user an adjustment to tuning parameters of the first RAG pipeline associated with: (i) a document ingestion tuning parameter, (ii) a chunk tuning parameter, (iii) an embed tuning parameter, (iv) a similarity search tuning parameter, and (v) a context tuning parameter;
automatically calculating an overall pipeline credibility score for the adjusted first RAG pipeline, including: (i) a retrieval accuracy metric, (ii) a context relevance metric, and (iii) an output coherence metric;
displaying the overall pipeline credibility score to the user; and
storing information about the adjusted first RAG pipeline into the RAG pipeline data store.

11. The method of claim 10, wherein the enterprise RAG pipeline engine is further to perform content filtering to ensure that the RAG pipeline data store does not contain at least one of: (i) sensitive content, (ii) inappropriate content, and (iii) harmful content.

12. The method of claim 10, wherein information about the credibility score is provided to a feedback loop to continuously improve pipeline performance via suggested tuning parameters.

13. The method of claim 10, wherein different RAG pipelines are associated with different document types.

14. The method of claim 10, wherein the information about the adjusted first RAG pipeline that is stored into the RAG pipeline data store is accessible by a second tenant.

15. The method of claim 14, wherein the RAG pipeline data store includes information about pipeline structure without including sensitive tenant information.

16. The method of claim 10, wherein the information about the adjusted first RAG pipeline that is stored into the RAG pipeline data store is accessible to multiple applications.

17. One or more non-transitory computer-readable media storing computer-executable instructions that, when executed by a computing system, cause the computing system to perform operations, comprising:
accessing, by a computer processor of an enterprise Retrieval-Augmented Generation (“RAG”) pipeline engine within a Generative Artificial Intelligence (“GenAI”) launchpad platform associated with at least one Large Language Model (“LLM”), information in a RAG pipeline data store associated with a first RAG pipeline that was created by a first tenant, the RAG pipeline data store contains electronic records that represent RAG pipelines, each record including a pipeline identifier and at least one tuning parameter;
receiving from a user an adjustment to a tuning parameter of the first RAG pipeline;
automatically calculating an overall pipeline credibility score for the adjusted first RAG pipeline;
displaying the overall pipeline credibility score to the user; and
storing information about the adjusted first RAG pipeline into the RAG pipeline data store.

18. The media of claim 17, wherein each RAG pipeline is associated with at least one of: (i) a document ingestion tuning parameter, (ii) a chunk tuning parameter, (iii) an embed tuning parameter, (iv) a similarity search tuning parameter, and (v) a context tuning parameter.

19. The media of claim 17, wherein the enterprise RAG pipeline engine is further to perform content filtering to ensure that the RAG pipeline data store does not contain at least one of: (i) sensitive content, (ii) inappropriate content, and (iii) harmful content.

20. The media of claim 17, wherein the overall pipeline credibility score includes a RAG triad comprising all of: (i) a retrieval accuracy metric, (ii) a context relevance metric, and (iii) an output coherence metric, wherein information about the RAG triad is provided to a feedback loop to continuously improve pipeline performance via suggested tuning parameters.
